(19) United States
(12) Patent Application Publication
(10) Pub. No.: US 2025/0233128 A1
(43) Pub. Date: Jul. 17, 2025

(54) POSITIVE ELECTRODE ACTIVE MATERIAL, NON-AQUEOUS ELECTROLYTE SECONDARY BATTERY, AND METHODS OF PRODUCING THEM

(71) Applicant: Prime Planet Energy & Solutions, Inc., Tokyo (JP)

(72) Inventor: Keiichi TAKAHASHI, Nishinomiya-shi (JP)

(21) Appl. No.: 19/012,849

(22) Filed: Jan. 8, 2025

(30) Foreign Application Priority Data
Jan. 11, 2024 (JP) 2024-002593

(51) Int. Cl. H01M 4/36; C01G 53/44; H01M 4/525

(52) U.S. Cl. CPC H01M 4/364; C01G 53/44; H01M 4/525; C01P 2002/50; C01P 2002/60; C01P 2004/50; C01P 2006/40

(57) ABSTRACT

A positive electrode active material comprises a first active material, and a second active material having a greater average particle size than the first active material. Each of the first active material and the second active material is a lithium-(transition metal) composite oxide including Ni at 75 mol % or more relative to a total number of moles of metallic element except Li. The first active material is a single particle, or a secondary particle consisting of 2 to 10 primary particles aggregated together, and the second active material is a secondary particle consisting of at least 50 primary particles aggregated together. A crystallite size L1 of the first active material is 80,000 Å or more. A crystallite size L2 of the second active material is 2,000 Å or less. A crystallite size ratio of the first active material (L₀₀₃/L₁₀₄) is from 1.60 to 2.0.

### CROSS REFERENCE TO RELATED APPLICATIONS

This nonprovisional application is based on Japanese Patent Application No. 2024-002593 filed on Jan. 11, 2024, with the Japan Patent Office, the entire contents of which are hereby incorporated by reference.

### BACKGROUND OF THE INVENTION

### Field of the Invention

The present invention relates to a positive electrode active material, a non-aqueous electrolyte secondary battery, and methods of producing them.

### Description of the Background Art

In non-aqueous electrolyte secondary batteries such as lithium-ion secondary batteries, it is known to use a lithium-(transition metal) composite oxide as a positive electrode active material in an active material layer of a positive electrode (for example, Japanese Patent Laying-Open No. 2021-114410).

### SUMMARY OF THE INVENTION

As active material in an active material layer of a positive electrode, two types of lithium-(transition metal) composite oxides with different particle sizes are used sometimes. In the case of mixing together two types of active materials having different particle sizes, for the purpose of improving packing properties in the active material layer, a high-sphericity (near spherical) active material is sometimes used. When a high-sphericity active material is used in a positive electrode, resistances of the non-aqueous electrolyte secondary battery such as direct-current resistance and charge-transfer resistance increase sometimes.

The present disclosure aims at providing a positive electrode active material with which the resistance of the positive electrode can be reduced, as well as a non-aqueous electrolyte secondary battery in which resistances such as direct-current resistance and charge-transfer resistance can be reduced.

[1] A positive electrode active material comprising:
a first active material; and
a second active material having a greater average particle size than the first active material, wherein
each of the first active material and the second active material is a lithium-(transition metal) composite oxide including Ni at 75 mol % or more relative to a total number of moles of metallic element except Li,
the first active material is a single particle, or a secondary particle consisting of 2 to 10 primary particles aggregated together,
the second active material is a secondary particle consisting of at least 50 primary particles aggregated together,
a crystallite size L1 of the first active material is 80,000 Å or more,
a crystallite size L2 of the second active material is 2,000 Å or less, and
a crystallite size ratio of the first active material (L₀₀₃/L₁₀₄) is from 1.60 to 2.0.

[2] The positive electrode active material according to [1], wherein the positive electrode active material includes the first active material at 20 to 55 weight %.

[3] The positive electrode active material according to [1] or [2], wherein a ratio of an average particle size (D₂50) of the second active material to an average particle size (D₁50) of the first active material (D₂50/D₁50) is from 2.4 to 8.5.

[4] The positive electrode active material according to any one of [1] to [3], wherein the lithium-(transition metal) composite oxide includes at least Ni, Co, and Mn as transition metal.

[5] A non-aqueous electrolyte secondary battery comprising an active material layer including the positive electrode active material according to any one of [1] to [4]. [6] A method of producing a positive electrode active material, wherein
the positive electrode active material is the positive electrode active material according to any one of [1] to [4],
the method comprises a step of producing the first active material, and the step includes:
a first calcination step of calcining a mixture including a lithium compound and a nickel-containing compound at a temperature within a range of 900 to 1000° C. to obtain a calcined product; and
a second calcination step of further calcining the calcined product at a calcination temperature less than a calcination temperature in the first calcination step for a calcination time at least 5 times longer than a calcination time in the first calcination step.

[7] The method of producing a positive electrode active material according to [6], wherein in the second calcination step, the calcinating is performed in an atmosphere at an oxygen concentration of 90% or more.

[8] The method of producing a positive electrode active material according to [6] or [7], wherein the calcination temperature in the second calcination step is less than the calcination temperature in the first calcination step by at least 80° C.

[9] A method of producing a non-aqueous electrolyte secondary battery having an active material layer including a positive electrode active material, wherein
the positive electrode active material is produced by the method of producing a positive electrode active material according to any one of [6] to [8].

The foregoing and other objects, features, aspects and advantages of the present invention will become more apparent from the following detailed description of the present invention.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table to set a new numerical range.

### Positive Electrode Active Material

A positive electrode active material according to the present embodiment is used in an active material layer of a positive electrode of a non-aqueous electrolyte secondary battery (hereinafter also called “a secondary battery”) such as a lithium-ion battery, for example. The positive electrode active material includes a first active material, and a second active material having a greater average particle size than the first active material. Each of the first active material and the second active material is a lithium-(transition metal) composite oxide including Ni at 75 mol % or more relative to a total number of moles of metallic element except Li. The first active material is a single particle, or a secondary particle consisting of 2 to 10 primary particles aggregated together. The second active material is a secondary particle consisting of at least 50 primary particles aggregated together. The crystallite size L1 of the first active material is 80,000 Å or more. The crystallite size L2 of the second active material is 2,000 Å or less. The crystallite size ratio of the first active material (L₀₀₃/L₁₀₄) is from 1.60 to 2.0.

With the positive electrode active material including the first active material and the second active material, packing properties of the positive electrode active material in the active material layer can be enhanced. As a result, volumetric energy density of a positive electrode obtained by using the positive electrode active material can be enhanced.

Each of the first active material and the second active material is a lithium-(transition metal) composite oxide, and the content of Ni relative to the total number of moles of metallic element except Li (hereinafter also called “the Ni content”) is 75 mol % or more. The composition of the first active material may be the same as, or may be different from, the composition of the second active material.

The Ni content of the lithium-(transition metal) composite oxide may be 78 mol % or more, or may be 80 mol % or more, or may be 82 mol % or more, or may be from 75 to 98 mol %, or may be from 80 to 95 mol %, or may be from 82 to 90 mol %. When the Ni content of the first active material and that of the second active material independently fall within the above-mentioned ranges, a secondary battery with a high energy density can be obtained.

The lithium-(transition metal) composite oxide is simply required to include Li and Ni, and preferably, it includes at least Ni, Co, and Mn as its transition metal. The lithium-(transition metal) composite oxide may be a compound represented by the following formula (I), for example.

Li₁₋ₐNiₓMe₁₋ₓO₂ (I)
[In the formula (I),
−0.3≤a≤0.3, and 0.75≤x≤1, and

Me may include one or more selected from the group consisting of Co, Mn, Al, Zr, Ti, Mg, Fe, Cu, Zn, Sn, Na, K, Ba, Sr, Ca, W, Mo, Nb, and Si.]

In the formula (I), a may be −0.25≤a≤0.25, or may be −0.20≤a≤0.20. x may be 0.78≤x≤0.99, or may be 0.80≤x≤0.95. Me may include one or more selected from the group consisting of Co, Mn, Al, Zr, Ti, Mg, Mo, and Nb, and it preferably includes at least one of Co and Mn, and more preferably includes Co and Mn.

The composition of the first active material and the second active material can be determined by ICP (high-frequency Inductively Coupled Plasma) emission spectrometry.

As long as the object of the present disclosure is not impaired, the positive electrode active material may include another active material, in addition to the first active material and the second active material. This another active material may be a lithium-(transition metal) composite oxide in which the content of Ni is outside the above-mentioned range, or a compound that is not a lithium-(transition metal) composite oxide. This another active material may be a primary particle, or may be a secondary particle.

### First Active Material

The first active material is a single particle, or a secondary particle consisting of 2 to 10 primary particles aggregated together. When the first active material is a secondary particle, the number of the primary particles aggregated together may be from 2 to 8, or may be from 2 to 5. The active material can become broken due to compression at the time of positive electrode production, as well as during charge/discharge of the secondary battery. Breakage of the active material, when it occurs, causes an increase of the specific surface area, making the reaction with electrolyte more likely to occur to produce gas, and/or making the expansion more likely to occur during charge/discharge of the secondary battery. Because the first active material is a single particle or a secondary particle consisting of a small number of primary particles aggregated together, it tends not to break due to the above-mentioned compression or charge/discharge, as compared to the second active material.

Therefore, when the positive electrode active material includes the first active material, gas production from the secondary battery and/or expansion of the secondary battery tends to be reduced.

The crystallite size L1 of the first active material is 80,000 Å or more, and it may be 85,000 Å or more, or may be 90,000 Å or more. The crystallite size L1 of the first active material is 100,000 Å or less, for example. When the crystallite size L1 falls within the above-mentioned range, formation of new surfaces after endurance testing tends to be inhibited. The crystallite size L1 is the average value of crystallite sizes attributable to all the diffraction peaks for the first active material observed by an X-ray diffraction method (hereinafter also called “an XRD method”), and can be measured by a method described below in Examples. The crystallite size L1 can be adjusted by changing the production conditions (sintering conditions, pulverization conditions) for first active material.

The crystallite size ratio of the first active material (L₀₀₃/L₁₀₄) is from 1.60 to 2.0, and it may be from 1.65 to 1.90, or may be from 1.70 to 1.85, or may be from 1.71 to 1.80. The crystallite size ratio of the first active material (L₀₀₃/L₁₀₄) is an index of the isotropy (sphericity) of the crystal structure of the crystallites in the first active material. It can be said that a crystallite of the first active material having the crystallite size ratio (L₀₀₃/L₁₀₄) falling within the above-mentioned range has a relatively large, nonisotropic shape. The crystallite sizes L₀₀₃ and L₁₀₄ of the first active material are the crystallite sizes attributable to the diffraction peaks for a (003) plane and a (104) plane, respectively, of the first active material measured by XRD, and can be measured by a method described below in Examples. The crystallite size ratio of the first active material (L₀₀₃/L₁₀₄) can be adjusted by changing the production conditions (sintering conditions, pulverization conditions) for first active material. Because the first active material is a single particle or a secondary particle consisting of a small number of primary particles aggregated together, irregularities on the surface of the first active material tend to be small and the particles tend to have smooth surfaces with small surface roughness. The first active material of the above-mentioned type having a smooth surface, when mixed with a second active material having a different average particle size, tends to have a small contact area. When the contact area between the first active material and the second active material is small, resistance to the movement of electrons within the active material layer of the positive electrode is great, which can cause an increase of various resistance components of the secondary battery. On the other hand, when the crystallite size ratio of the first active material (L₀₀₃/L₁₀₄) falls within the above-mentioned range, it is conjectured that the crystallite in the first active material has a flat, round shape. This can increase the contact area between the first active material and the second active material, and, therefore, resistance to the movement of electrons within the active material layer of the positive electrode can be reduced.

The average particle size (D₁50) of the first active material may be from 1 to 10 μm, or may be from 2 to 9 μm, or may be from 3 to 8 μm, for example. Herein, the average particle size refers to the particle size (D50) in volume-based particle size distribution at which cumulative frequency of particle sizes accumulated from the small size side reaches 50%. The volume-based particle size distribution can be measured with a laser-diffraction particle size distribution analyzer.

The content of the first active material in the positive electrode active material, relative to the total weight of the positive electrode active material regarded as 100 weight %, is preferably from 20 to 55 weight %, and it may be from 25 to 50 weight %, or may be from 30 to 45 weight %.

### Second Active Material

The second active material is a secondary particle consisting of at least 50 primary particles aggregated together. In the second active material, the number of the primary particles aggregated together may be 100 or more, or may be 500 or more, or may be 1,000 or more, or may be 5,000 or more, and it is usually 5×10⁶ or less, and may be 5×10⁵ or less.

The crystallite size L2 of the second active material is 2,000 Å or less, and it may be 1,900 Å or less, or may be 1,800 Å or less. Preferably, the crystallite size L2 of the second active material is from 800 to 2,000 Å, and it may be from 1,000 to 1,900 Å, or may be from 1,200 to 1,800 Å, or may be from 1500 to 1800 Å. Because the second active material is a secondary particle consisting of many primary particles aggregated together, when the crystallite size L2 is small, irregularities on the surface of the second active material tend to be small and surface roughness tends to be small. Therefore, when the second active material having the crystallite size L2 falling within the above-mentioned range and the first active material having the average particle size smaller than the second active material are mixed together, the contact area between the first active material and the second active material tends to be large. The crystallite size L2 is the average value of crystallite sizes attributable to all the diffraction peaks for the second active material observed by XRD, and can be measured by a method described below in Examples. The crystallite size L2 can be adjusted by changing the production conditions (sintering conditions, pulverization conditions) for second active material.

The average particle size (D₂50) of the second active material may be from 5 to 25 μm, or may be from 10 to 22 μm, or may be from 12 to 20 μm, for example.

The ratio of the average particle size (D₂50) of the second active material to the average particle size (D₁50) of the first active material (D₂50/D₁50) is preferably from 2.4 to 8.5, and it may be from 2 to 8, or may be from 3 to 7. When the ratio (D₂50/D₁50) falls within the above-mentioned range, packing properties (packing density) of the active material layer tend to be enhanced.

The content of the second active material in the positive electrode active material is preferably from 45 to 80 weight %, and it may be from 50 to 75 weight %, or may be from 55 to 70 weight %, relative to the total weight of the positive electrode active material regarded as 100 weight %.

Preferably, the second active material has a round shape, or a near-round shape. Such a shape can enhance the fluidity of the positive electrode active material, and, as a result, when a composite material including the positive electrode active material is applied to a positive electrode current collector, problems such as breakage of the positive electrode current collector can be inhibited.

The crystallite size ratio of the second active material (L₀₀₃/L₁₀₄) may be from 1.1 to 1.9, or may be from 1.2 to 1.85, or may be from 1.3 to 1.8. The crystallite sizes L₀₀₃ and L₁₀₄ of the second active material are the crystallite sizes attributable to the diffraction peaks for a (003) plane and a (104) plane measured by XRD, and can be measured by a method described below in Examples. The crystallite size ratio of the second active material (L₀₀₃/L₁₀₄) can be adjusted by changing the production conditions for second active material.

### Method of Producing Positive Electrode Active Material

A method of producing a positive electrode active material according to the present embodiment includes a step of producing a first active material, and it may include a step of producing a second active material. By the present production method, it is possible to obtain the above-mentioned first active material. In the present production method, the step of producing a first active material includes:
a first calcination step of calcining a mixture including a lithium compound and a nickel-containing compound at a temperature within the range of 900 to 1000° C. to obtain a calcined product; and
a second calcination step of further calcining the calcined product at a calcination temperature less than the calcination temperature in the first calcination step for a calcination time at least 5 times longer than the calcination time in the first calcination step.

The step of producing the first active material may involve pulverizing the calcined product obtained in the first calcination step and subjecting the calcined product thus pulverized to the second calcination step.

Examples of the lithium compound include lithium hydroxide, lithium carbonate, and the like. Examples of the nickel-containing compound include composite oxides and composite hydroxides containing Ni and a metallic element represented by Me in the above-mentioned formula (I).

The calcination temperature in the first calcination step (hereinafter also called “the first calcination temperature”) may be from 920 to 980° C., or may be from 930 to 970° C. By adjusting the first calcination temperature, it is possible to adjust the size of the single particle or the primary particle of the first active material. The time for the first calcination step (hereinafter also called “the first calcination time”) is from 1 to 100 hours, for example, and it may be from 1 to 50 hours, or may be from 1 to 10 hours. The oxygen concentration in the first calcination step is from 90 to 100%, for example, and it may be from 92 to 98%, or may be from 93 to 96%.

The calcination temperature in the second calcination step (hereinafter also called “the second calcination temperature”) is not particularly limited as long as it is less than the first calcination temperature. The second calcination temperature is preferably less than the first calcination temperature by at least 80° C., more preferably by at least 100° C., further preferably by at least 120°. The temperature difference between the first calcination temperature and the second calcination temperature is 400° C. or less, for example. The second calcination temperature is from 500 to 920° C., for example, and it may be from 600 to 900° C., or may be from 700 to 850° C. By adjusting the second calcination temperature, it is possible to adjust the crystallite size ratio of the first active material (L₀₀₃/L₁₀₄).

The time for the second calcination step (hereinafter also called “the second calcination time”) is not particularly limited as long as it is at least 5 times longer than the first calcination time. The second calcination time may be at least 5.2 times, or at least 5.5 times, longer than the first calcination time. The second calcination time is at most 8 times longer than the first calcination time, for example. The second calcination time is from 5 to 500 hours, for example, and it may be from 5 to 100 hours, or may be from 7 to 30 hours, or may be from 7 to 20 hours. By adjusting the second calcination time, it is possible to adjust the crystallite size ratio of the first active material (L₀₀₃/L₁₀₄).

The oxygen concentration in the second calcination step is preferably 90% or more, and it may be 95% or more, or may be 100%. With adjustment of the oxygen concentration in the second calcination step, a first active material having the above-mentioned crystallite size ratio tends to be obtained.

The second active material can be obtained by calcining a mixture including a lithium compound and a nickel-containing compound. At the time of producing the second active material, calcination of the mixture may be carried out in one step, or may be carried out in two or more steps. By adjusting the calcination conditions such as the calcination temperature and the calcination time, it is possible to adjust the crystallite size L2 and the crystallite size ratio (L₀₀₃/L₁₀₄) of the second active material. The method of producing a positive electrode active material may include a step of mixing the first active material and the second active material produced in the above-mentioned manner. The first active material and the second active material can be mixed together with the use of a mixer such as a blender.

### Non-Aqueous Electrolyte Secondary Battery

A non-aqueous electrolyte secondary battery according to the present embodiment (hereinafter also called “the present battery”) comprises a positive electrode, and the positive electrode has an active material layer including the above-mentioned positive electrode active material. Therefore, with the present battery, it is possible to reduce resistances such as direct-current resistance and charge-transfer resistance.

Usually, the present battery includes an electrode assembly that includes the positive electrode, as well as a non-aqueous electrolyte solution. The present battery may have a battery case for accommodating the electrode assembly and the non-aqueous electrolyte solution. The battery case can include an exterior package having an opening, and a sealing plate for sealing the opening. Each of the exterior package and the sealing plate can be formed with a metal such as, for example, Al, Al alloy, iron, or iron alloy, and, for example, it can be formed by using an Al-laminated film. Between the electrode assembly and the exterior package, a resin sheet may be provided as an electrode holder.

The electrode assembly may include the positive electrode, a negative electrode, and a separator. In the electrode assembly, the active material layer of the positive electrode faces a negative electrode active material layer of the negative electrode, with the separator interposed therebetween. The electrode assembly may be a stack-type one that is formed by stacking the positive electrode, the negative electrode, and the separator, or may be a wound-type one that is formed by stacking the positive electrode, the negative electrode, and the separator and winding the resulting stack.

The positive electrode has a positive electrode current collector and an active material layer including the above-mentioned positive electrode active material, and the active material layer is present on the positive electrode current collector. The active material layer is formed on one side or both sides of the positive electrode current collector. The positive electrode current collector is a metal foil that is made by using an Al material such as Al and Al alloy, for example, and the metal foil is not particularly limited as long as it is stable at the electric potential range of the positive electrode.

The active material layer can be formed by, for example, applying a composite material to the positive electrode current collector, drying, and compression. The composite material can be prepared by adding a solvent to an active-material-layer-forming material such as the positive electrode active material, a binder, and a conductive material, and mixing and kneading the resultant.

In addition to the above-mentioned positive electrode active material, the active material layer may include a binder, a conductive material, and the like. The binder may be a known material, such as, for example, a fluororesin such as polyvinylidene difluoride and polytetrafluoroethylene and a cellulose-based resin such as carboxymethylcellulose (CMC). The conductive material may be a carbon material, for example. The carbon material may be one or more selected from the group consisting of fibrous carbon, carbon black, coke, and activated carbon, for example. The fibrous carbon may be carbon nanotubes (CNTs), for example.

Usually, the negative electrode has a negative electrode current collector, as well as a negative electrode active material layer formed on one side or both sides of the negative electrode current collector. As the negative electrode current collector, a known material may be used. The negative electrode active material layer may include a known negative electrode active material, a conductive material, a binder, and the like.

The separator has a monolayered or multilayered base material, and on at least one side of the base material, it may have a functional layer such as an adhesive layer and/or a heat-resistant layer. The base material is a porous sheet such as a film and/or a nonwoven fabric made of a resin such as polyolefin (such as polyethylene and/or polypropylene), for example.

The non-aqueous electrolyte solution is preferably obtained by adding an electrolyte to a non-aqueous solvent such as an organic solvent. As the electrolyte and the non-aqueous solvent, known materials can be used.

### Method of Producing Non-Aqueous Electrolyte Secondary Battery

The present battery has an active material layer including a positive electrode active material, and a method of producing the present battery includes a step of producing a positive electrode active material by the above-mentioned method of producing a positive electrode active material. The method of producing the present battery may further include a step of obtaining an electrode assembly by using a positive electrode, a negative electrode, and a separator, and a step of accommodating the electrode assembly and a non-aqueous electrolyte solution in a battery case.

### EXAMPLES

In the following, the present disclosure will be described in further detail by way of Examples and Comparative Examples.

### Measurement of Average Particle Size of Active Material

The average particle sizes of the first active material and the second active material (D₁50 and D₂50) were measured with a laser-diffraction particle size distribution analyzer.

### Calculation of Crystallite Sizes L1 and L2

The crystallite sizes of the first active material and the second active material, L1 and L2, were determined by acquiring an X-ray diffraction (XRD) profile for the range of 15 to 110° with the use of an XRD apparatus (manufactured by Rigaku, “SmartLab”). More specifically, Δθ, namely, the values of full width at half maximum (FWHM) of the diffraction peaks on an XRD profile acquired for the active material was substituted into the Scherrer equation to form a structure model with correction in accordance with 2θ/θ values, and by WPPF analysis with the use of Rietveld analysis software, the crystallite sizes attributable to the diffraction peaks were determined. The crystallite sizes thus determined for all the diffraction peaks obtained from the XRD profile were averaged, and the resulting value was regarded as the crystallite size of the active material (L1, L2).

### Calculation of Crystallite Size Ratio (L₀₀₃/L₁₀₄)

By the procedure described in Calculation of Crystallite Sizes L1 and L2, the crystallite sizes Loo3 and L104 attributable to the diffraction peaks for a (003) plane and a (104) plane, among all the diffraction peaks on the XRD profile, were determined, and the crystallite size ratio (L₀₀₃/L₁₀₄) was calculated.

### Example 1

### (Preparation of Positive Electrode Active Material)

A mixture of lithium hydroxide monohydrate as a lithium compound and nickel-cobalt-manganese hydroxide as a nickel-containing compound was calcined at 950° C. for 2 hours, to obtain a calcined product (a first calcination step). The calcined product was subjected to pulverization treatment, and then the calcined product thus pulverized was calcined in an atmosphere at an oxygen concentration of 94%, at 750° C., for 12 hours (a second calcination step), to obtain a first active material. The first active material was a lithium-(transition metal) composite oxide that included Ni at 83 mol % relative to the total number of moles of metallic element except Li and also included Co and Mn. The first active material had the average particle size (D₁50), the crystallite size L1, and the crystallite size ratio (L₀₀₃/L₁₀₄) shown in Table 1. The first active material was a single particle or a secondary particle consisting of 2 to 10 primary particles aggregated together.

As a second active material, a lithium-(transition metal) composite oxide that had the average particle size (D₂50), the crystallite size L2, and the crystallite size ratio (L₀₀₃/L₁₀₄) shown in Table 1 and that included Ni at 81.5 mol % relative to the total number of moles of metallic element except Li and also included Co and Mn was used. The second active material was a secondary particle consisting of 6,000 to 10,000 primary particles aggregated together. Mixing was carried out with a blender at 50 rpm for 5 minutes so as to obtain a positive electrode active material containing the first active material at 40 weight % and the second active material at 60 weight %.

### (Preparation of Positive Electrode)

The positive electrode active material, a conductive material, a binder, and the like were mixed together, and mixed and kneaded with a kneader while a proper amount of solvent was being added thereto, to obtain a composite material. The composite material was applied to a positive electrode current collector, dried, and compressed to form an active material layer, and, thereby, a positive electrode having the active material layer formed on the positive electrode current collector was obtained.

### Examples 2 to 5, Comparative Examples 1 to 5

The same procedure as in Example 1 was followed except for adjustment of, for example, the conditions of the first calcination step and the second calcination step, to obtain first active materials having the average particle size (D₁50), the crystallite size L1, and the crystallite size ratio (L₀₀₃/L₁₀₄) shown in Table 1 and Table 2. The first active material was a single particle or a secondary particle consisting of 2 to 10 primary particles aggregated together. Moreover, second active materials having the average particle size (D₂50), the crystallite size L2, and the crystallite size ratio (L₀₀₃/L₁₀₄) shown in Table 1 and Table 2 were prepared. The second active material was a secondary particle consisting of 6,000 to 10,000 primary particles aggregated together. The first active material and the second active material included Ni at 83 mol % and 81.5 mol %, respectively, relative to the total number of moles of metallic element except Li. Each of the first active material and the second active material was a lithium-(transition metal) composite oxide including Co and Mn.

The same procedure as in Example 1 was followed except for using the first active material and the second active material specified in Table 1 and Table 2, to prepare positive electrodes.

### Measurement of Pressed Powder Resistance of Positive Electrode Active Material

The positive electrode active material obtained in Examples and Comparative Examples (mixed powder of the first active material and the second active material) was compressed at 0.5 MPa to measure the value of resistance, which was regarded as the pressed powder resistance of the positive electrode active material. The lower the value of the pressed powder resistance is, the greater the contact area between the first active material and the second active material is considered to be. Results are shown in Table 1 and Table 2.

### Measurement of Resistance of Cell (Measurement of Direct-Current Resistance Rₛ and Charge-Transfer Resistance R_{CT})

The positive electrode prepared in Examples and Comparative Examples was placed in a manner to face an artificial graphite negative electrode, with a separator interposed therebetween, and the resultant was accommodated inside a battery case, followed by injection of a non-aqueous electrolyte solution to prepare a laminate-type cell. The cell was charged to 3.7 V, followed by use of an impedance analyzer at a frequency from 0.05 mHz to 5 MHz to obtain a Nyquist plot. On the complex plane with the real part of impedance on the horizontal axis and the imaginary part of impedance on the vertical axis, from the value of the intercept on the high-frequency side on the real axis, direct-current resistance Rₛ of the cell was calculated, and from the value corresponding to the radius of the semicircle on the low-frequency side, charge-transfer resistance R_{CT} of the cell was calculated. Results are shown in Table 1 and Table 2.

### Measurement of Resistance of Positive Electrode

The cell prepared in Measurement of Resistance of Cell was disassembled, and the positive electrode was taken out, rinsed, and dried. With an electrical resistance measurement system (manufactured by Hioki, “RM2610”), the resistance of the positive electrode was measured. The lower the resistance of the positive electrode is, the greater the contact area between the first active material and the second active material in the active material layer is considered to be even after the cell was charged. Results are shown in Table 1 and Table 2.

TABLE 1

| | Ex. 1 | Ex. 2 | Ex. 3 | Ex. 4 | Ex. 5 |
|---|---|---|---|---|---|
| First active material | | | | | |
| Crystallite size L1 [Å] | 93718 | 94037 | 96582 | 99603 | 99959 |
| L₀₀₃ [Å] | 1115 | 1193 | 1183 | 1138 | 999.3 |
| L₁₀₄ [Å] | 649.8 | 673.6 | 664.1 | 638.1 | 582.8 |
| L₀₀₃/L₁₀₄ | 1.72 | 1.77 | 1.78 | 1.78 | 1.71 |
| D₁50 [μm] | 4.2 | 4.2 | 4.3 | 4.2 | 4.2 |
| Second active material | | | | | |
| Crystallite size L2 [Å] | 1783 | 1783 | 1783 | 1783 | 1783 |
| L₀₀₃ [Å] | 1184 | 1184 | 1184 | 1184 | 1184 |
| L₁₀₄ [Å] | 664.1 | 664.1 | 664.1 | 664.1 | 664.1 |
| L₀₀₃/L₁₀₄ | 1.78 | 1.78 | 1.78 | 1.78 | 1.78 |
| D₂50 [μm] | 17.4 | 17.4 | 17.4 | 17.4 | 17.4 |
| Ratio of average particle | 4.14 | 4.14 | 4.05 | 4.14 | 4.14 |
| size (D₂50/D₁50) | | | | | |
| Pressed powder resistance | 143 | 123 | 131 | 123 | 117 |
| of positive electrode | | | | | |
| active material [Ω] | | | | | |
| Direct-current resistance | 0.28 | 0.32 | 0.33 | 0.33 | 0.32 |
| of cell, R_{S} [Ω] | | | | | |
| Charge-transfer resistance | 0.87 | 0.89 | 0.88 | 0.87 | 0.86 |
| of cell, R_{CT} [Ω] | | | | | |
| Resistance of positive | 0.445 | 0.345 | 0.384 | 0.452 | 0.456 |
| electrode [Ω] | | | | | |

TABLE 2

| | Comp. | Comp. | Comp. | Comp. | Comp. |
|---|---|---|---|---|---|
| | Ex. 1 | Ex. 2 | Ex. 3 | Ex. 4 | Ex. 5 |
| First active material | | | | | |
| Crystallite size L1 [Å] | 88481 | 99975 | 99987 | 99401 | 86583 |
| L₀₀₃ [Å] | 800.8 | 1588 | 1772 | 1087 | 912.1 |
| L₁₀₄ [Å] | 796.9 | 1234 | 1261 | 1084 | 571.9 |
| L₀₀₃/L₁₀₄ | 1.00 | 1.29 | 1.41 | 1.00 | 1.59 |
| D₁50 [μm] | 2.2 | 4.2 | 4.2 | 4.2 | 6.4 |
| Second active material | | | | | |
| Crystallite size L2 [Å] | 1783 | 1133 | 1783 | 2635 | 1783 |
| L₀₀₃ [Å] | 1184 | 962.5 | 1184 | 1263 | 1184 |
| L₁₀₄ [Å] | 664.1 | 662.1 | 664.1 | 902.8 | 664.1 |
| L₀₀₃/L₁₀₄ | 1.78 | 1.45 | 1.78 | 1.40 | 1.78 |
| D₂50 [μm] | 17.4 | 15.2 | 17.4 | 19.8 | 17.4 |
| Ratio of average particle | 7.91 | 3.62 | 4.14 | 4.71 | 2.72 |
| size (D₂50/D₁50) | | | | | |
| Pressed powder resistance | 225 | 225 | 225 | 225 | 225 |
| of positive electrode | | | | | |
| active material [Ω] | | | | | |
| Direct-current resistance | 0.45 | 0.42 | 0.42 | 0.43 | 0.42 |
| of cell, R_{S} [Ω] | | | | | |
| Charge-transfer resistance | 1.21 | 1.16 | 1.14 | 1.12 | 1.22 |
| of cell, R_{CT} [Ω] | | | | | |
| Resistance of positive | 0.782 | 0.562 | 0.643 | 0.564 | 0.631 |
| electrode [Ω] | | | | | |

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode active material comprising:
a first active material; and
a second active material having a greater average particle size than the first active material, wherein
each of the first active material and the second active material is a lithium-(transition metal) composite oxide including Ni at 75 mol % or more relative to a total number of moles of metallic element except Li,
the first active material is a single particle, or a secondary particle consisting of 2 to 10 primary particles aggregated together,
the second active material is a secondary particle consisting of at least 50 primary particles aggregated together,
a crystallite size L1 of the first active material is 80,000 Å or more,
a crystallite size L2 of the second active material is 2,000 Å or less, and
a crystallite size ratio of the first active material (L₀₀₃/L₁₀₄) is from 1.60 to 2.0.

2. The positive electrode active material according to claim 1, wherein the positive electrode active material includes the first active material at 20 to 55 weight %.

3. The positive electrode active material according to claim 1, wherein a ratio of an average particle size (D₂50) of the second active material to an average particle size (D₁50) of the first active material (D₂50/D₁50) is from 2.4 to 8.5.

4. The positive electrode active material according to claim 1, wherein the lithium-(transition metal) composite oxide includes at least Ni, Co, and Mn as transition metal.

5. A non-aqueous electrolyte secondary battery comprising:
a positive electrode, wherein
the positive electrode has an active material layer including the positive electrode active material according to claim 1.

6. A method of producing a positive electrode active material, wherein
the positive electrode active material is the positive electrode active material according to claim 1,
the method comprises a step of producing the first active material, and
the step includes:
a first calcination step of calcining a mixture including a lithium compound and a nickel-containing compound at a temperature within a range of 900 to 1000° C. to obtain a calcined product; and
a second calcination step of further calcining the calcined product at a calcination temperature less than a calcination temperature in the first calcination step for a calcination time at least 5 times longer than a calcination time in the first calcination step.

7. The method of producing a positive electrode active material according to claim 6, wherein in the second calcination step, the calcinating is performed in an atmosphere at an oxygen concentration of 90% or more.

8. The method of producing a positive electrode active material according to claim 6, wherein the calcination temperature in the second calcination step is less than the calcination temperature in the first calcination step by at least 80° C.

9. A method of producing a non-aqueous electrolyte secondary battery having an active material layer including a positive electrode active material, wherein
the positive electrode active material is produced by the method of producing a positive electrode active material according to claim 6.
